(19) United States
(12) Patent Application Publication
(10) Pub. No.: US 2002/0087464 A1
(43) Pub. Date: Jul. 4, 2002

(54) Method of direct funding

(76) Inventor: Amy Galland, Venice, CA (US)

Correspondence Address: Amy Galland, 79 Hidden Ridge Dr., Syosset, NY, 11791, US

(21) Appl. No.: 09/752,592

(22) Filed: Jan. 2, 2001

(51) Int. Cl. G06F 17/60

(52) U.S. Cl. 705/39

(57) ABSTRACT

The present invention provides a method of directly funding projects comprising soliciting proposals desiring funding, posting the proposal on a server, connecting the server to the Internet and receiving an inquiry from at least one client device responding to the proposal. The present invention also provides a network based system of direct funding of projects comprising at least one client device, at least one server. In addition, the server includes software which posts on the Internet proposals desiring funding and receives responses to the posting from the client. The present invention also includes a network based system of direct funding of projects comprising a means for soliciting proposals desiring funding, a means for posting the proposals on a server, a means for connecting the server to the Internet and a means for receiving an inquiry from a client device responding to the proposals.

### BACKGROUND OF THE INVENTION

1. Field of Invention

The present invention generally relates to a method of funding projects and particularly to a method of direct funding using the Internet.

2. Description of the Related Art

Currently, most of the funding to the arts and much of the funding in the sciences is provided by private foundations and government organizations on the state, local, and national levels. Although the sources of money, vision, and capabilities of the different organizations differ, they are structurally similar. The different organizations each have an endowment that earns income. This income is divided to cover the costs of running the organization, and a percentage of the endowment is given to a specified number of grants for predetermined amounts of money.

The number of projects funded are limited by the finite number of grants and monies of each organization. For this reason, many good projects are left unfunded, and even more are only partially funded due to the mandates of the granting organizations.

Therefore, it would be desirable to have a method of funding that allows individuals to directly donate to the art or science project of their choice.

### SUMMARY OF THE INVENTION

The present invention provides a method of directly funding projects comprising soliciting proposals desiring funding, posting the proposal on a server, connecting the server to the Internet and receiving an inquiry from at least one client device responding to the proposal.

The present invention also provides a network based system of direct funding of projects comprising at least one client device, at least one server and wherein the server includes software which posts on the Internet proposals desiring funding and receives inquiries to the posting from the at least one client.

The present invention also includes a network based system of direct funding of projects comprising a means for soliciting proposals desiring funding, a means for posting the proposals on a server, a means for connecting the server to the Internet and a means for receiving a response from a client device responding to the proposals.

### DETAILED DESCRIPTION OF THE PREFERRED EMBODIMENTS

A first embodiment of the invention uses the unique capabilities of the Internet to facilitate direct funding to artists' projects. It will help to fill the ever-widening gap between the artists' needs and extant funding opportunities by introducing the on-line public to interesting arts projects by individuals and arts organizations and encouraging the visitors to a site to give them their financial support. The embodiment includes a web service that allows the public to give money directly to individual art projects. It fosters a commitment to the potential of the artist and to fostering an environment supportive of her or his creative pursuits.

The embodiment bypasses the restrictions of the endowment-based grants system. It will give the artists the monies they need to complete their projects, and will not be limited to a given number of grants per year. The web service connects artists with potential funders on an individual basis through communications via bulletin boards, emails and chat-rooms.

Currently, no arts organizations have successfully tapped into the pool of individual donors.

The invention uses the Internet to introduce donors to interesting arts projects and organizations. An organization using the invention accepts and reviews applications which contain a biography of the artist/organization, examples of previous work, and a project proposal. The applications are reviewed by panels of specialists and if considered of merit, are put up for funding. The organization puts the selected applications on line, i.e. the application is posted on a server attached to the Internet. Patrons using a client computer can visit the site can make a donation to the organization with a request for the monies to be put towards their project of choice.

Donations may be made in the form of a direct transfer of money such as a credit card debit authorization or a payment of Internet cash. Additionally, donations may be made by pledging money and being billed later.

Unlike in traditional charitable donations, where the money is given to the group and used as the directors see fit, donors have total control as to where their money goes.

Once an individual has made a donation to an artist or organization, she or he will be given access to communicate with that person, thereby creating a community between artists and patrons more in line with a now mostly dormant system of patronage in which there is a relationship between the sponsor and artist. As part of the initial contract, the artist will be asked to communicate about the progress of the project, and to answer questions posed by the donors.

By bringing arts funding to the public, artists are not bound by the politics of granting committees in order to receive financial support. As long as the work is considered of merit by members of the committee, there need be no consensus for them to be given the opportunity to be presented for funding.

The public decides who it wants to fund on an individual basis, thereby also by passing what are often politically charged attitudes toward what should or should not be supported. If an individual does not think a work should be supported, she or he does not have to give money towards that project.

An organization using the first embodiment of the invention will be supported by donations to its operating costs and by collecting a percentage of the donations. Preferably, the organization will appropriate less than 10% of donations to artists, thus leaving more than 90% of collected funds going directly to artists. This is far below the approved 35% of collected funds for administrative fees as established by the Better Business Bureau.

In a second embodiment of the invention, an organization desiring to fund science projects accepts and reviews applications which contain a biography of the scientist/organization, examples of previous work, and a project proposal. The applications are reviewed by panels in the scientist's field and if considered of merit, are put up for funding. The organization puts the selected applications on line, i.e. the application is posted on a server attached to the Internet. Patrons using a client computer can visit the site can make a donation to the organization with a request for the monies to be put towards their project of choice.

In a third embodiment of the invention, an organization desiring to fund various charities, or not for profit organizations accepts and reviews applications which contain a description of the charity/organization, examples of previous works, and a project proposal. The applications are reviewed by panels familiar with the charity and/or related charities and if considered of merit are put up for funding. The organization puts the selected applications on line, i.e. the application is posted on a server attached to the Internet. Patrons using a client computer can visit the site can make a donation to the organization with a request for the monies to be put towards their project of choice.

We claim:

1. A method of directly funding projects comprising:
soliciting proposals desiring funding;
posting said proposal on a server;
connecting said server to the Internet and receiving an inquiry from at least one client device concerning said proposal.

2. The method of claim 1, wherein said project is an art project.

3. The method of claim 1, wherein said project is a science project.

4. The method of claim, wherein said project is a not for profit organization.

5. The method of claim 1, wherein said inquiry is a pledge.

6. The method of claim 1, wherein said inquiry comprises a direct transfer of money.

7. The method of claim 5, wherein said direct transfer of money comprises receiving a credit card debit authorization from a client.

8. The method of claim 5, wherein said direct transfer of money comprise payment of Internet cash to the solicitor.

9. The method of claim 1, further comprising the step of crediting funds to the project desiring funds.

10. A network based system of direct funding of projects comprising:
at least one client device;
at least one server; and
wherein said server includes software which posts on the Internet proposals desiring funding and receives inquiries to the posting from the at least one client.

11. The network based system of claim 9, further comprising software to allocate finds based on the inquiries to the projects.

12. A network based system of direct funding of projects comprising:
a means for soliciting proposals desiring funding;
a means for posting the proposals on a server;
a means for connecting the server to the Internet; and
a means for receiving an inquiry from a client device responding to the proposals.

13. The network based system of claim 11, further comprising a means for distributing finds to the authors of the proposals.
